(19) United States
(12) Patent Application Publication
(10) Pub. No.: US 2005/0129027 A1
(43) Pub. Date: Jun. 16, 2005

(54) Traffic contract parameter estimation in an ATM network

(76) Inventors: Joe R. Costanza, Monument, CO (US); Vonn Leland Black, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/732,251

(22) Filed: Dec. 11, 2003

(51) Int. Cl. H04L 12/56

(52) U.S. Cl. 370/395.21

(57) ABSTRACT

A method and storage medium having computer-executable instructions stored thereon estimate traffic contract parameters in an asynchronous transfer mode (ATM) network. The method and the computer-executable instructions include: generating data for ATM cell packet arrival times of a number of cells received for a predetermined period of time; determining a sustained cell rate (SCR) parameter; determining the PCR parameter; generating PCR leaky bucket data and SCR leaky bucket data; determining a cell delay variation tolerance parameter (CDVT) utilizing the PCR leaky bucket data; and determining a maximum burst size (MBS) parameter utilizing the SCR leaky bucket data.

### BACKGROUND OF THE INVENTION

1. Field of the Invention

This invention relates to network communication utilizing asynchronous transfer mode (ATM) and in particular, to estimation of traffic contract parameters in an ATM network.

2. Description of the Related Art

Asynchronous Transfer Mode (ATM) networks are the world's most widely deployed type of standard network to process broadband-ISDN traffic. ATM is a connection-oriented transfer mode that transmits user data in units called cells. A virtual connection between a source and a destination is established before the cells are sent. The virtual connection employs Virtual Paths (VP) and Virtual Channels (VC). Each VP has a plurality of VCs. The cells of a selected connection follow a same path within the network. When a connection is set up, each switch on the path generates an entry in the Virtual Path Identifier (VPI)/Virtual Channel Identifier (VCI) translation table so that the switch may move an incoming packet from its VP/VC to a corresponding outgoing VP/VC.

ATM networks allow input traffic from users to vary from one call to another and also within the call. The ATM network negotiates call parameters with a user, enters into a contract with the user wherein the contract specifies the negotiated call parameters, and implements a method to control the traffic flow across the user network interface based on the negotiated call parameters. The network then uses the negotiated call parameters from a plurality of users of the network to determine a traffic that would produce efficient network performance. Thus, a traffic controller may determine whether the negotiated call parameters may be fulfilled.

Generally, traffic control and congestion control is utilized to protect the network and the user so that desired network performance objectives may be met and so that network resources may be optimized. ATM networks have two levels of congestion and control—the call level and the cell level. With ATM connections, there is a unidirectional specification of the Quality of Service (QoS) parameters. These parameters are specified at connection setup and are guaranteed by the network. To guarantee the QoS parameters, the network must be able to obtain sufficient information from the user about the connection and be able to ensure that no other connections that share the resources degrade the QoS parameters below the specified level. A user enters into a contract with the network to specify the user's desired call parameters for a desired QoS level, and the network implements traffic control to avoid, in advance, problems that may degrade the QoS level below the user's desired QoS level. To implement traffic control, the network typically may utilize Network Resource Management (NRM), Call Admission Control (CAC), Usage Parameter Control (UPC), and selective cell discard.

Within the ATM cell, certain bits are specified, typically in the header, for setting congestion and priority levels. A low priority cell may be subject to being discarded by the network during times of congestion.

Previous policing determinations of whether cell traffic conforms to predetermined contract parameters have required that the operator enter the associated contract parameters. Since Switched Virtual Circuit (SVC) environments may often have thousands of connections, such an approach is difficult to employ. Also, if the user does not know the contract parameters in advance for a particular VP/VC channel, policing behavior on the circuit may not be verified.

### SUMMARY OF THE INVENTION

It is a general aspect of an embodiment of the present invention to provide a method of estimating traffic contract parameters in an asynchronous transfer mode (ATM) network that includes generating data for ATM cell packet arrival times of a number of cells received for a predetermined period of time; determining a sustained cell rate (SCR) parameter; determining the peak cell rate (PCR) parameter; generating PCR leaky bucket data and SCR leaky bucket data; determining a cell delay variation tolerance parameter (CDVT) utilizing the PCR leaky bucket data; and determining a maximum burst size (MBS) parameter utilizing the SCR leaky bucket data.

In an aspect, the SCR parameters can be determined by using a collection of cell arrival-time bins. These bins hold the total packet count (hits) for each of the possible cell-arrival delta-times on a given ATM network interface within a specific VP/VC connection. (See FIG. 1).

The SCR parameter is calculated by using a cluster of cell arrival-time bins. The bin cluster that is included in this calculation centers around a locus that represents the most frequently seen cell arrival-time. The SCR locus is found by searching through all the available bins for the maximum count value. The SCR parameter calculation involves a weighted average of this SCR locus bin, at least one bin immediately prior (and adjacent) to the SCR locus bin, and at least one bin immediately following (and adjacent to) the SCR locus bin.

In an aspect, the PCR parameters can be determined by using a collection of cell arrival-time bins. These bins hold the total packet count (hits) for each of the possible cell-arrival delta-times on a given ATM network interface within a specific VP/VC connection. (See FIG. 1).

The PCR parameter is calculated by using a cluster of cell arrival-time bins. The bin cluster that is included in this calculation centers around a locus that represents the most frequently seen cell arrival-time that is not already a part of the SCR cluster. This PCR locus is found by searching for the maximum bin count from among all the remaining bins with arrival-times that are smaller than the SCR locus. The PCR parameter calculation involves a weighted average of the PCR locus bin, at least one bin immediately prior (and adjacent) to the PCR locus bin, and at least one bin immediately following (and adjacent to) the PCR locus bin.

Where a PCR parameter fails to be detected because a PCR locus cannot be detected above the noise floor, cell traffic is assumed to be a constant bit rate (CBR) connection. In that case, the SCR value calculated earlier is assigned to the PCR parameter and no SCR traffic contract parameters are used. If a PCR locus is available, then the cell traffic may be assumed to be part of a variable bit rate (VBR) connection where the remaining CDVT, and MBS parameters must be determined.

A cell delay variation tolerance parameter (CDVT) may be determined by averaging values from a predetermined band-pass peak-detection scheme over a predetermined range of instantaneous PCR leaky bucket levels. (See FIG. 2)

A cell delay variation tolerance plus burst tolerance value (CDVT+BT) may be determined by averaging values from a low-pass peak-detection scheme over a predetermined range of instantaneous SCR leaky bucket levels. (See FIG. 3)

The maximum burst size (MBS) parameter is derived using the previous parameter estimates (PCR, SCR, CDVT, and CDVT+BT) via a rework of the standard GCRA equation.

A storage medium may have stored thereon computer-executable instructions to estimate traffic contract parameters in the asynchronous transfer mode (ATM) network in accordance with the previously recited method.

The above-mentioned features and advantages of the present invention, together with other aspects and advantages, which will become apparent, will be more fully described hereinafter, with reference being made to the accompanying drawings which form a part hereof, wherein like numerals refer to like parts throughout.

Additional aspects and advantages of the invention will be set forth in part in the description which follows and, in part, will be obvious from the description, or may be learned by practice of the invention.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 is a graphical representation of an example of a Cell Delay Variation algorithm output upon processing of a selected group ATM cells associated with a VP/VC connection;

FIG. 2 illustrates a graphical representation of an example of a time history for a PCR leaky bucket level;

FIG. 3 illustrates a graphical representation of an example of a time history for an SCR leaky bucket level; and

FIG. 4 is a flow chart illustrating an embodiment of operations of a method in accordance with the present invention.

### DETAILED DESCRIPTION OF THE EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

Traffic control protects the network so that required performance objectives are achieved. UPC enforces a contract between the user and the network about the nature of the call, thus preventing any one user from causing excessive traffic and degrading the QoS provided to the other users. It is necessary to determine the worst traffic that a user can inflict on the network while still abiding by the UPC. A leaky bucket algorithm is commonly used to implement the UPC.

The leaky bucket algorithm is a flow control algorithm, where cells are monitored to check whether they comply with the connection parameters. Non-conforming cells may be tagged as violators or dropped from the network. The analogy of the leaky bucket is taken from a bucket (memory buffer) with a hole in the bottom that allows the fluid (cells) to flow out at a certain rate. The leaky bucket algorithm generally refers to a set of algorithms known as the Generic Rate Control Algorithms (GCRA). These algorithms implement a flow control policer based on a continuous state leaky bucket.

Hence, in a leaky bucket implementation, as is known to those skilled in the art, cells typically flow into the leaky bucket (memory buffer) at a bursty rate and leak out (flow into the network) at a fixed rate. The rate that the cells flow into the network is determined by the “leak rate” using the PCR and/or SCR parameters. Cell bursts are determined by the “bucket depth” using CDVT and/or MBS parameters. The BT parameter is related to the MBS parameter and is also used in policing traffic. If the parameter values for PCR, CDVT, SCR and MBS parameters exceed the values specified in the traffic contract for a user, the traffic in excess of the specific values may be discarded due to service provider policing.

A traffic contract specifies the negotiated characteristics of the connection. A connection traffic descriptor is the set of traffic parameters in the source traffic descriptor, the cell delay variation tolerance and the conformance definition. The conformance definition is used to decide which cells are conforming in the connection. A typical conformance definition is the Leaky Bucket or GCRA, although a number of such algorithms may be used in tandem. The CAC uses the connection traffic descriptor to allocate resources and to derive parameters for the UPC. The connection traffic descriptors are enforceable by the UPC. However, even if a cell is non-conforming, the connection is not necessarily non-conforming. The precise definition of a compliant connection is determined by the network operator. Clearly, if all cells are conforming, the connection is compliant. The traffic contract includes the connection traffic descriptor and requested QoS for each direction of the connection, including the definition of a compliant connection. Traffic supported by a private UNI may differ from traffic supported by a public UNI.

Generally, a request for connection to the network includes a description of the traffic parameters and the Quality of Service parameters required by the user. The network determines whether sufficient resources are available and whether addition of the user's QoS would violate the QoS of other users. If the network has the available resources and the user's QoS would not violate the QoS of other users, the network accepts the request.

The ATM forum has defined four traffic contract parameters used in their Generic Cell Rate Algorithm (GCRA). These parameters refer to a transmission contract that the GCRA may use to shape ATM traffic on a selected VP/VC connection. The contract parameters are: the Peak Cell Rate (PCR) parameter, which is an upper bound for a cell rate of the source traffic; the Sustained Cell Rate (SCR) parameter, which is the average cell rate measured over a predetermined interval; the Cell Delay Variation Tolerance (CDVT) parameter, which is the maximum burst size that may be sent at the maximum cell rate; and the Maximum Burst Size (MBS) parameter, which is the maximum burst size that may be sent at the PCR.

In an embodiment of the present invention, for CDVT values, band-pass peak detection averaging may be utilized. Similarly, in an embodiment to determine CDVT+BT values (to calculate MBS—see below), low-pass peak detection averaging may be utilized.

The ATM forum's conformance definition defines conformity at an interface with respect to traffic contracts according to one or more instances of the GCRA. The GCRA allows cells to pass into a buffer or “leaky bucket” as long as there is space for the cells. At the same time, the leaky bucket leaks cells into the network at a specified rate, providing more space for additional cells. If a cell arrives at the leaky bucket when the bucket is full, the cell may be discarded or tagged as a violator.

Mathematically, the GCRA is defined in accordance with the following equation:

GCRA(T,τ)
t: cell arrival time
tat: theoretical arrival time
if(t<tat-τ)

cell nonconforming

else

```
  cell conforming
  tat = max(t,tat)+T.
```

That is, the GCRA compares the arrival time of each new cell with the Theoretical Arrival Time (tat). If the cell is late, i.e., the cell rate is lower than its nominal rate, the cell is accepted by the ATM network. If the cell is early, the deviation in time is checked to determine whether the deviation is within a predetermined tolerable limit (τ), and if so, the cell is accepted by the ATM network. Otherwise, the cell may be discarded or tagged as a violator.

The ATM Forum's GCRA work operationally defines a relationship between the four main traffic contract parameters: PCR, SCR, CDVT, and MBS. While the CDVT+BT values produced by the GCRA process are a part of these definitions, the CDVT+BT item itself is not commonly identified as a discrete traffic contract parameter the way that MBS is.

Complete and uniform testing of ATM networks with high-level performance measurement and protocol analysis has been achieved by a variety of network test systems, such as the AGILENT TECHNOLOGIES J6800 series of Network Analyzers and the E4334A Broadband Series Test System. The Cell Delay Variation measurement, as defined by the GCRA, is a key measurement that provides an indication of the level of jitter from a specified cell arrival time.

The present invention includes a method and storage medium having stored thereon computer-executable instructions to implement the method, in which traffic contract parameters are estimated automatically in an asynchronous transfer mode (ATM) network. The method analyzes the pattern of cell arrival times within an ATM network to determine contract parameters and may also be utilized to determine ATM switch configuration errors. The present invention automatically estimates all of the ATM policing contract parameters for all VP/VC channels in a traffic sample. The contract parameters may then be input to a standard GCRA to help identify non-conforming traffic. Further, the operator may identify whether a policing contract is too restrictive or too generous for the actual traffic on the network being examined. The present invention provides estimates of traffic parameters that reveal characteristics of traffic patterns so that the ATM traffic behavior may be more readily understood.

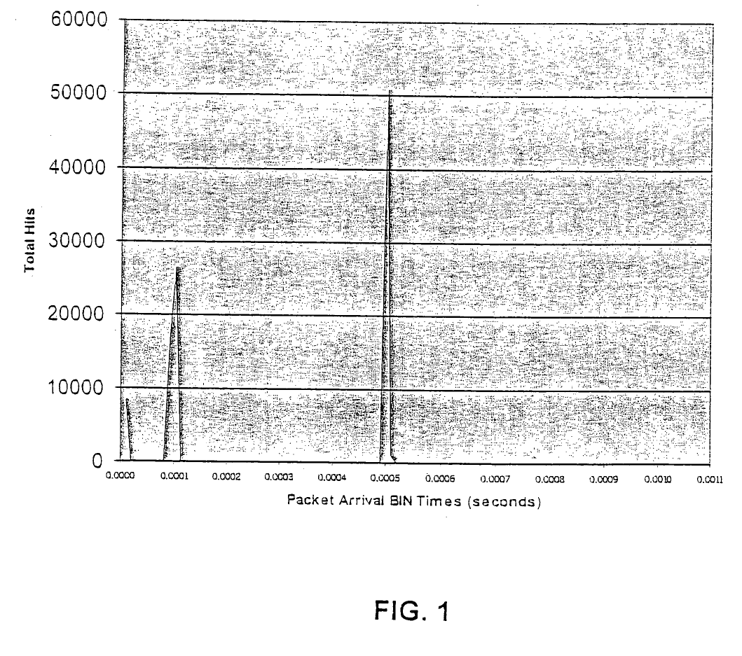

In an embodiment of the present invention, each of the ATM cells associated with a selected VP/VC connection is first processed by AGILENT's 1-Point Cell Delay Variation (CDV) algorithm, which is set forth in U.S. patent application Ser. No.10/631426, titled “Apparatus and Method for Intra-Cell Delay Time Analysis,” filed Jul. 31, 2003, by inventors Joe Costanza and Vonn Black et al. and which is incorporated by reference herein in its entirety. Referring to drawings, embodiments of the present invention are hereinafter described in detail. An example of a CDV output is shown in FIG. 1.

Although the methods of the present invention are described with respect to an implementation using AGILENT TECHNOLOGIES test and measurement systems, such as the AGILENT TECHNOLOGIES J6800 series of Network Analyzers and the E4334A Broadband Series Test System, as is known to those skilled in the art, the methods of the present invention may be implemented using numerous test and measurement hardware, general purpose computers and the like. Thus, the methods presented herein are not inherently related to any particular device or operating system, and are not limited thereto. Machines that may perform the functions of the present invention include those that may be manufactured by other manufacturers of test and measurement systems and general computing devices.

FIG. 1 is a BIN Chart graphical representation, i.e., a CDV output graph, of packet arrival BIN times in seconds plotted versus total hits, i.e., total cells received, for an example in which VP/VC is 5.500. After generating data for ATM cell packet arrival times for a number of cells received during a predetermined period of time, the Sustained Cell Rate (SCR) is identified for a selected VP/VC connection. A maximizing search function searches the CDV output to identify peaks that are above a pre-defined noise floor. When the maximum value is located, then the weighted average of at least three bin-times (the maximum bin-time and the bin-times immediately before and after the maximum bin-time) is calculated to determine the SCR value. In the example shown in FIG. 1, the weighted average results in a time of approximately 500 μsec, or approximately 2000 cells per second.

Next, the Peak Cell Rate (PCR) parameter value is determined by performing a maximizing search function similar to that of the SCR parameter. However, in the maximizing search for the PCR parameter value, only the bin-times that correspond to cell-rates faster than the SCR parameter value are included in the search. Thus, the search begins where the SCR parameter value ends and continues upward to the Maximum Cell Rate (MCR). In the example shown in FIG. 1, the search begins at the SCR parameter value and moves left to the beginning of the graph. Once the localized maximum is found, the weighted average of at least three bin-times (the localized maximum bin-time and the bin-times immediately before and after the localized maximum bin-time) is calculated to determine the PCR parameter value. In the example from FIG. 1, the weighted average results in a time of approximately 100 psec, or approximately 10,000 cells per second.

If no PCR parameter value is found above the noise floor, then the traffic is identified as a Constant Bit Rate (CBR) connection. In such an instance, no additional processing is required. If both the SCR and the PCR parameter values are found in the CDV parameter value output, then the traffic is classified as Variable Bit rate (VBR), and additional processing is necessary to determine the remaining contract parameters (see below).

In an embodiment of the present invention, the last two ATM contract parameters, the CDVT and MBS parameters, are determined. To calculate these contract parameters, a time history of the GCRA leaky bucket output for both the PCR parameter and the SCR parameter is utilized such that the CDVT and CDVT+BT limits are infinite and no cells are dropped.

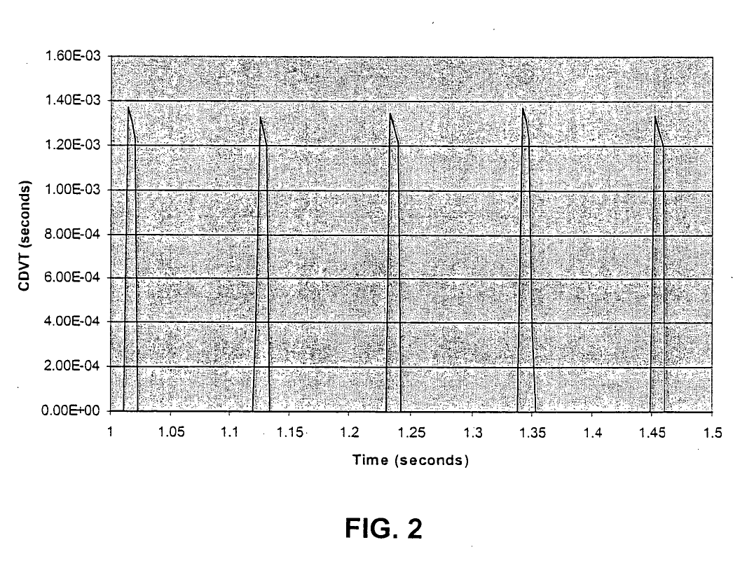

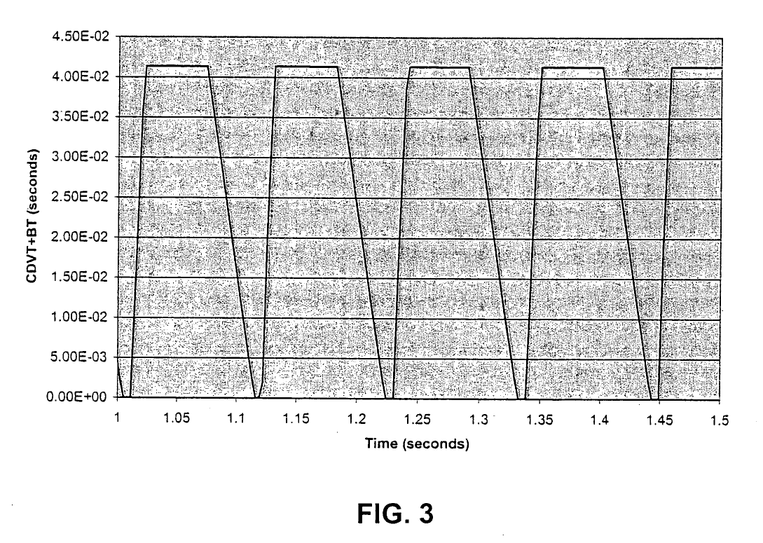

FIG. 2 illustrates a graphical representation of an example of a time history for a PCR parameter. In FIG. 2, time in seconds is shown on the horizontal axis and the CDVT parameter value is plotted in seconds on the vertical axis. FIG. 3 illustrates a graphical representation of an example of a time history for an SCR parameter. In FIG. 3, time in seconds is shown on the horizontal axis, and CDVT+BT parameter value is plotted in seconds on the vertical axis. FIGS. 2 and 3 indicate the instantaneous leaky bucket utilization history levels at any given time in the traffic sample. When the specialized maximizing search through the PCR leaky bucket output example shown in FIG. 2 is performed, a maximum CDVT parameter value is obtained. Similarly, performing a specialized maximizing search through the SCR leaky bucket output example shown in FIG. 3 yields a largest CDVT+Burst Tolerance (BT) parameter value. The CDVT+BT parameter values are produced by the GCRA, as is known to those skilled in the art. Then the BT parameter is obtained as follows: BT=(CDVT+BT)−CDVT.

The relationship between the BT and MBS parameters is well known to those skilled in the art, and is described below, in accordance with the GCRA equation:
BT=(MBS−1)*(1/SCR−1/PCR),
which may be rearranged as follows:
MBS=1+{BT/(1/SCR−1/PCR)}.

The phrase “specialized maximizing search” recited above refers to a search to identify multiple peaks at or near a same level at various locations within the leaky bucket history record. This is done because there may be instances in which the traffic sent on a selected VP/VC link is not demanding enough to require the GCRA engine within an ATM switch to shape the traffic. In such cases, the spikes in the leaky bucket history graphs are highly erratic in their amplitudes. If the method of the present invention detects such a highly erratic pattern in the data, then it flags the traffic as insufficient to determine the ATM traffic contract limits. Thus, in order to utilize the method of the present invention, the ATM switch is required to shape the traffic during the sample interval being analyzed so that the method of the present invention may identify the cell-arrival traffic patterns that provide the indications of the contract limits.

Upon determining the values for the SCR parameter, the PCR parameter, the CDVT parameter and the MBS parameter, the four values are used to populate a list of contract parameters for the user so that, in policing the contract, the network operator may determine, for example, whether a user is in need of more network facilities.

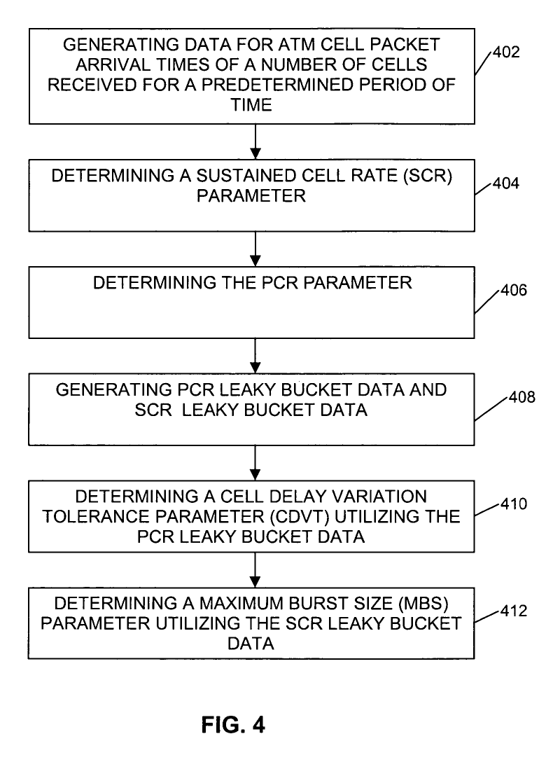

As shown in FIG. 4, an embodiment of a method of the present invention estimates traffic contract parameters in an asynchronous transfer mode (ATM) network, and includes: an operation of generating data for ATM cell packet arrival times of a number of cells received for a predetermined period of time (402); an operation of determining a sustained cell rate (SCR) parameter (404); an operation of determining the PCR parameter (406); an operation of generating PCR leaky bucket data and SCR leaky bucket data (408); an operation of determining a cell delay variation tolerance parameter (CDVT) utilizing the PCR leaky bucket data (410); and an operation of determining a maximum burst size (MBS) parameter utilizing the SCR leaky bucket data (416). Although the operations of the method are itemized in the order cited above, the operations are not limited to such an order.

In an embodiment, the SCR parameter may be determined using a first cell arrival rate bin in which a largest peak occurs, and computing a weighted average of the first cell arrival rate bin in which a largest peak occurs, at least one cell rate bin immediately prior to the first cell arrival rate bin in which a largest peak occurs and at least one cell rate bin immediately following the first cell arrival rate bin in which a largest peak occurs.

In an embodiment, the PCR parameter may be determined using a second cell arrival rate bin that occurs at a faster arrival time than a first cell arrival rate bin in which a largest peak occurs and that has a largest peak cell arrival rate bin in a range between zero and the time of the first cell arrival rate bin in which the largest peak occurs. For example, the PCR parameter may be determined by computing a weighted average of the second cell arrival rate bin, at least one cell rate bin immediately prior to the second cell arrival rate bin and at least one cell rate bin immediately following the second cell arrival rate bin.

In an embodiment, a cell delay variation tolerance parameter (CDVT) may be determined by averaging values from a predetermined band-pass peak-detection scheme over a predetermined range of instantaneous PCR leaky bucket data. Similarly, a cell delay variation tolerance plus a burst tolerance (CDVT+BT) parameter may be determined by averaging values from a low-pass peak-detection scheme over a predetermined range of instantaneous SCR leaky bucket data. Then, a maximum burst size (MBS) parameter may be determined from the CDVT+BT parameter using previous estimates of contract parameters PCR, SCR, and CDVT (see equations above).

Where desired, the method of the present invention may be implemented by a storage medium having stored thereon computer-executable instructions to estimate traffic contract parameters in an asynchronous transfer mode (ATM) network, wherein the computer-executable instructions include the operations recited above.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of estimating traffic contract parameters in an asynchronous transfer mode (ATM) network, comprising:
generating data for ATM cell packet arrival times of a number of cells received for a predetermined period of time;
determining a sustained cell rate (SCR) parameter;
determining the peak cell rate (PCR) parameter;
generating PCR leaky bucket data and SCR leaky bucket data;
determining a cell delay variation tolerance parameter (CDVT) utilizing the PCR leaky bucket data; and
determining a maximum burst size (MBS) parameter utilizing the SCR leaky bucket data.

2. The method of claim 1, wherein the SCR parameter is determined using a first cell arrival rate bin in which a largest peak occurs.

3. The method of claim 2, wherein the SCR parameter is determined by computing a weighted average of the first cell arrival rate bin in which a largest peak occurs, at least one cell rate bin immediately prior to the first cell arrival rate bin in which a largest peak occurs and at least one cell rate bin immediately following the first cell arrival rate bin in which a largest peak occurs.

4. The method of claim 1, wherein the PCR parameter is determined using a second cell arrival rate bin that occurs at a faster arrival time than a first cell arrival rate bin in which a largest peak occurs and that has a largest peak cell arrival rate bin in a range between zero and the time of the first cell arrival rate bin in which the largest peak occurs.

5. The method of claim 4, wherein the PCR parameter is determined by computing a weighted average of the second cell arrival rate bin, at least one cell rate bin immediately prior to the second cell arrival rate bin and at least one cell rate bin immediately following the second cell arrival rate bin.

6. The method of claim 1, wherein, if the PCR parameter fails to be available, cell traffic is managed by a constant bit rate (CBR) connection.

7. The method of claim 1, wherein a cell delay variation tolerance parameter (CDVT) is determined by averaging values from a predetermined band-pass peak-detection scheme over a predetermined range of instantaneous PCR leaky bucket data.

8. The method of claim 1, wherein a cell delay variation tolerance parameter plus a burst tolerance (CDVT+BT) is determined by averaging values from a low-pass peak-detection scheme over a predetermined range of instantaneous SCR leaky bucket data.

9. The method of claim 8, wherein a maximum burst size (MBS) is determined from the CDVT+BT using previous estimates of contract parameters PCR, SCR, and CDVT.

10. A storage medium having stored thereon computer-executable instructions to estimate traffic contract parameters in an asynchronous transfer mode (ATM) network by:
generating data for ATM cell packet arrival times of a number of cells received for a predetermined period of time;
determining a sustained cell rate (SCR) parameter;
determining the peak cell rate (PCR) parameter;
generating PCR leaky bucket data and SCR leaky bucket data;
determining a cell delay variation tolerance parameter (CDVT) utilizing the PCR leaky bucket data; and
determining a maximum burst size (MBS) parameter utilizing the SCR leaky bucket data.

11. The storage medium of claim 10, wherein the SCR parameter is determined using a first cell arrival rate bin in which a largest peak occurs.

12. The storage medium of claim 11, wherein the SCR parameter is determined by computing a weighted average of the first cell arrival rate bin in which a largest peak occurs, at least one cell rate bin immediately prior to the first cell arrival rate bin in which a largest peak occurs and at least one cell rate bin immediately following the first cell arrival rate bin in which a largest peak occurs.

13. The storage medium of claim 10, wherein the PCR parameter is determined using a second cell arrival rate bin that occurs at a faster arrival time than a first cell arrival rate bin in which a largest peak occurs and that has a largest peak cell arrival rate bin in a range between zero and the time of the first cell arrival rate bin in which the largest peak occurs.

14. The storage medium of claim 13, wherein the PCR parameter is determined by computing a weighted average of the second cell arrival rate bin, at least one cell rate bin immediately prior to the second cell arrival rate bin and at least one cell rate bin immediately following the second cell arrival rate bin.

15. The storage medium of claim 10, wherein, if the PCR parameter fails to be available, cell traffic is managed by a constant bit rate (CBR) connection.

16. The storage medium of claim 10, wherein a cell delay variation tolerance parameter (CDVT) is determined by averaging values from a predetermined band-pass peak-detection scheme over a predetermined range of instantaneous PCR leaky bucket data.

17. The storage medium of claim 10, wherein a cell delay variation tolerance parameter plus a burst tolerance (CDVT+BT) is determined by averaging values from a low-pass peak-detection scheme over a predetermined range of instantaneous SCR leaky bucket data.

18. The storage medium of claim 8, wherein a maximum burst size (MBS) is determined from the CDVT+BT using previous estimates of contract parameters PCR, SCR, and CDVT.

19. The method of claim 1, further including analyzing a pattern of cell arrival times within the ATM network to determine ATM switch configuration errors.

20. The storage medium of claim 10, further including analyzing a pattern of cell arrival times within the ATM network to determine ATM switch configuration errors.
